(19) United States
(12) Patent Application Publication
(10) Pub. No.: US 2004/0052623 A1
(43) Pub. Date: Mar. 18, 2004

(54) Trailer with operable ramp

(76) Inventor: Keith Legum, Bend, OR (US)

Correspondence Address: GLENN C. BROWN, PC, 777 NW WALL STREET, SUITE 308, BEND, OR, 97701, US

(21) Appl. No.: 10/648,746

(22) Filed: Aug. 25, 2003

Related U.S. Application Data
(60) Provisional application No. 60/407,609, filed on Aug. 27, 2002.

(51) Int. Cl. B62B 1/00

(52) U.S. Cl. 414/482

(57) ABSTRACT

A trailer having an upper surface for transporting vehicles, and operable to reposition the upper surface to provide an angled ramp or jump for use with vehicles such as motorcycles and other recreational vehicles.

### BACKGROUND OF RELATED APPLICATION

This application is a continuation of U.S. provisional patent application serial No. 60/407,609, filed on Aug. 27, 2002. The priority of the prior application is expressly claimed and its disclosure is hereby incorporated by reference in its entirety.

### BACKGROUND OF THE INVENTION

This invention relates to trailers, and in particular for a trailer that includes an operable ramp that can be configured to provide a launching ramp for use with motorcycles, all terrain vehicles and the like.

A growing number of motorcycle and all terrain vehicle (ATV) riders are participating in acrobatic or free-style or jumping. The rider approaches an angled ramp at a relatively high speed, and is launched into the air. While in the air the rider performs acrobatic maneuvers or tries to go the farthest in the air. The ramp must be sturdy enough to withstand the impact of the vehicle and rider, and in most cases is erected on site, either as a permanent or temporary structure. While such ramps are entirely adequate, they are not readily available in most locations.

The present invention is embodied in a trailer that can serve two functions. First, it can be used as a trailer to transport motorcycles or ATV's. The novel and non-obvious feature of this invention is that it can be reconfigured to provide a stable launching ramp in essentially any location.

### BRIEF DESCRIPTION OF THE DRAWINGS

FIG. 1 is a side elevational view of a preferred embodiment of the invention.

FIG. 2 is a front elevational view of the embodiment shown in FIG. 1.

FIG. 3 is a top plan view of the embodiment shown in FIG. 1

FIG. 4 is a side elevational view of the embodiment shown in FIG. 1 and which is configured to serve as a launch ramp.

FIG. 5 is a perspective view of the frame portion of the preferred embodiment.

### DETAILED DESCRIPTION OF THE PREFERRED EMBODIMENT

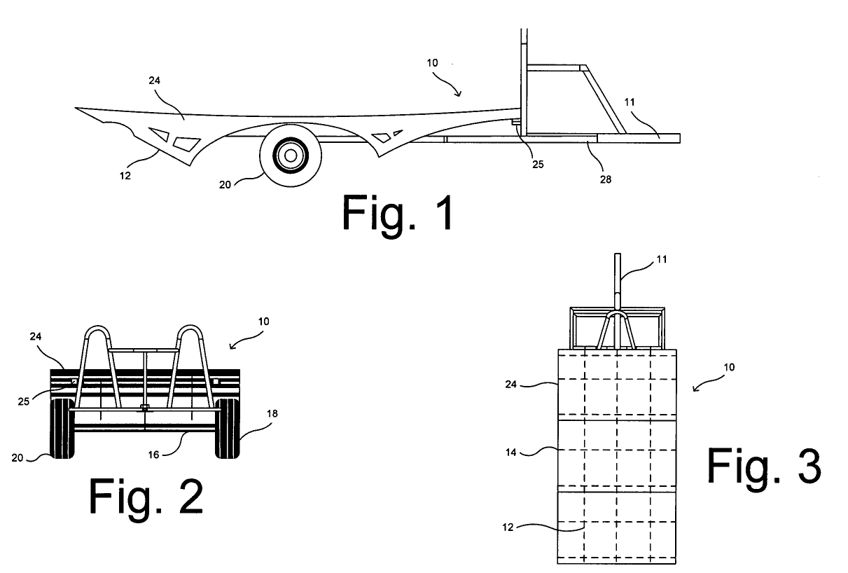

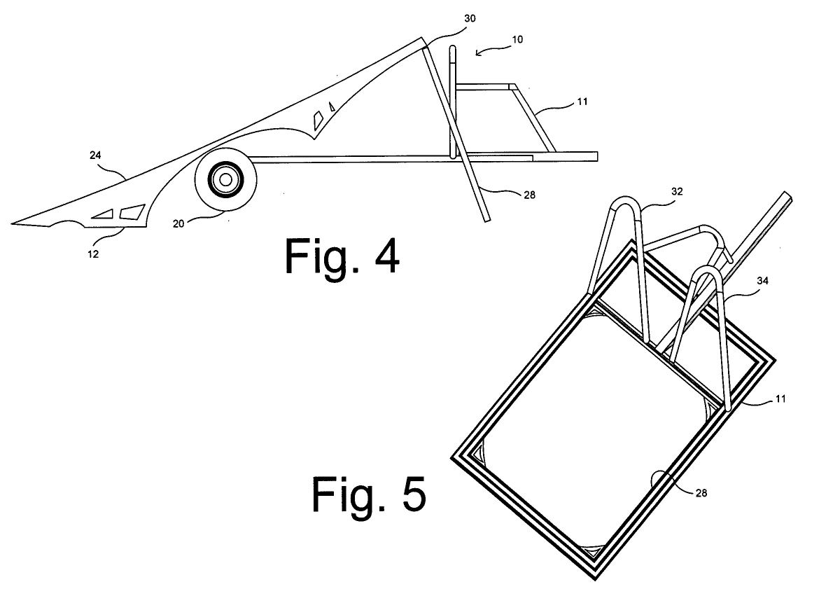

Turning to the drawings, a trailer according to a preferred embodiment of the invention is shown in FIGS. 1-4 generally at 10. The trailer is a space frame construction including a frame 11. An axle assembly 16 is mounted to the frame 11 and supports left and right wheels 18 and 20. A rectangular ramp platform 24 is pivotally mounted on frame 11, and includes longitudinal ribs 12 and transverse ribs 14, onto which is mounted a platform 24. The upper surface of platform 24 is slightly concave in the preferred embodiment, although the invention is not limited to any particular shape of platform. Platform 24 is pivotally mounted and includes a first position where it is substantially horizontal as shown in FIG. 1, and in which it is suitable for carrying motorcycles, ATV's, snowmobiles and the like. When in this position the front edge of platform 24 rests on member 25, and is preferably locked into place in position by being secured to member 25, although other methods of securing the platform in place could also be utilized. Platform 24 can be pivoted to a second, raised position as shown in FIG. 4 in which it serves as a tilted ramp. When in the raised position, a rear portion of longitudinal ribs 12 rest on the ground to support the rear of the platform. The center portion of the platform is supported by the pivoting attachment to frame 11, which in the preferred embodiment is attached to the frame 11 just behind the transverse axle 16. The front surface of platform 24 is supported by a pivoting frame member 28 that is rotated from a position parallel with frame 11 to an angled position in which the front end(s) rest on the ground and the rear edges and a transverse member 30 support the front of the platform. The platform 24 is thereby supported firmly enough to withstand the impact and forces transferred thereto when used as a ramp. In the preferred embodiments the pivoting frame member 28 rotates to an angled position that reflects the direction of forces applied to the ramp by a vehicle that is moving forward and upward relative to the ground.

Other features of the preferred embodiment include a pair of upright frames 32 and 34 that are provided to secure motorcycles or other vehicles to the platform during transport.

The invention has been described above in terms of the preferred embodiment. Those of skill in the art will recognize that numerous changes in detail and arrangement are possible without departing from the scope of the invention.

What is claimed is:

1. A trailer comprising:
a frame having a front transverse support member and pivotable front support member;
the pivotable front support member operable from a first position to a second position;
a platform pivotably mounted on the frame, the platform having a upper surface;
the platform operable from a first position where the upper surface is approximately horizontal, to a second position where the upper surface is angled upwardly and its rear edge is supported on an underlying surface; and,
the platform supported in its second position at its front portion by the pivotable front support member in its second position where the front support member has a first end in contact with a platform front portion and a second end resting on an underlying surface.

2. A trailer according to claim 1 wherein the platform further comprises at least one longitudinal member supporting the upper surface.

3. A trailer according to claim 1 wherein the platform upper surface is concave.

4. A trailer according to claim 1 wherein the front support member first position includes the front support member is parallel to the platform in its first position.

5. A trailer according to claim 1 wherein the front support member in its second position is generally perpendicular to the platform in its second position.

6. A trailer according to claim 2 wherein at least one longitudinal member includes an elongated lower surface that is parallel to an underlying surface when the platform is in its second position.

7. A trailer according to claim 1 further comprising:
a pair of wheels mounted on the frame, the wheels having a first position in contact with an underlying surface when the platform is in its first position, and a second position above an underlying surface when the platform is in its second position.

8. A trailer according to claim 1 wherein the upper surface comprises a vehicle ramp adapted to launch a vehicle into the air when in its second position.

9. A trailer according to claim 1 wherein the upper surface comprises a vehicle transport surface when in its first position.

10. A trailer according to claim 1 wherein the front support member includes a transverse member and left and right longitudinal members connected to respective left and right portions of the transverse members, and the left and right transverse members pivotably mounted to respective left and right portions of the frame.
